(19) United States
(12) Patent Application Publication
(10) Pub. No.: US 2017/0307255 A1
(43) Pub. Date: Oct. 26, 2017

(54) Methods and Systems for Heating Water with In-Line Magnetic Induction

(71) Applicants: Jeremy Spring, Brewerton, NY (US); Stephen Spring, JR., Liverpool, NY (US)

(72) Inventors: Jeremy Spring, Brewerton, NY (US); Stephen Spring, JR., Liverpool, NY (US)

(21) Appl. No.: 15/497,605

(22) Filed: Apr. 26, 2017

Related U.S. Application Data
(60) Provisional application No. 62/327,506, filed on Apr. 26, 2016.

(51) Int. Cl. F24H 9/20; F24H 1/14; H05B 6/10

(52) U.S. Cl. CPC F24H 9/2028; H05B 6/108; F24H 1/142; F24H 2250/08

(57) ABSTRACT

An apparatus, method, and device for heating water using in-line magnetic induction. The heating system utilizes eddy currents created via one or more magnetic fields acting upon a stationary ferrous core. The device can be housed within an enclosure, which can in turn be connected to any existing water line, and can be connected to basic house voltage. During operation, cold water enters the enclosure, passes through the system, and leaves the system at a desired temperature setpoint greater than the initial inlet water temperature.

### CROSS-REFERENCE TO RELATED APPLICATIONS

This application is a continuation of and claims priority to co-pending U.S. Patent Application No. 62/327,506, filed Apr. 26, 2016, and now allowed, entitled “Methods and Systems for Heating Water with In-Line Magnetic Induction,” the entire contents of which are incorporated herein by reference in its entirety.

### FIELD OF THE INVENTION

The present invention relates to methods and systems for heating water and, more specifically, to devices for heating water using in-line magnetic induction systems.

### BACKGROUND

Traditional domestic and commercial water heaters typically comprise a large tank in which water is maintained at a constant high temperature. A burner is controlled by a thermostat which helps maintain the water temperature. Over the past few decades these traditional water heaters have become more energy efficient through means of improved insulation as well as more efficient burner and ignition systems. However, all traditional water heaters waste energy maintaining water temperature even at times of no or low demand. For example, if the users of the heated water are sleeping or go away on vacation for days or weeks, the traditional water heating systems will continue to expend energy maintaining the water at a constant high temperature.

On-demand water heating systems are known and provide several advantages over traditional water heating systems. For example, on-demand water heaters do not include a tank of water maintained at a high temperature even at times of no or low demand; instead, these systems only expend energy to heat water when there is a demand for hot water. Accordingly, many on-demand water heater functions by heating the cold or lukewarm water flowing the device to the desired temperature. Many on-demand water heaters can also be smaller and require less room due to the lack of a large storage tank for the water.

However, on-demand or “tankless” water heating systems suffer from several important limitations. For example, these tankless systems can require a significant amount of time to warm up and bring the water flowing through the device to the desired temperature. Also, these devices can have a difficult time operating efficiently in an environment where there are frequent starts and stops of water flow. Further, tankless water heating systems may have difficulty working in an environment where there is a prolonged period of hot water demand.

Accordingly, there is a continued need in the art for improved, energy-efficient on-demand and tankless water systems, methods, and devices that provide a steady flow of heated water in a variety of different demand environments.

### SUMMARY OF THE INVENTION

The present disclosure is directed to methods, systems, and devices for heating water using in-line magnetic induction systems. For example, the heating system utilizes eddy currents created via one or more magnetic fields acting upon a stationary ferrous core. The device can be housed within an enclosure, which can in turn be connected to any existing water line, and can be connected to basic house voltage. During operation, cold water enters the enclosure, passes through the system, and leaves the system at a desired temperature setpoint greater than the initial inlet water temperature.

According to an aspect is an on-demand water heating system. The system includes: an inlet configured to receive water of a first temperature from a water supply; a metal heating component configured to transfer heat to the water of a first temperature received via the inlet, the heating region comprising: (i) a controller; (ii) an induction driver configured to receive a command input from the controller; (iii) an induction coil configured to induce, in response to a current from the induction driver, eddy currents in the metal heating component, wherein induction of eddy currents heats the metal heating component, and wherein the heated metal heating component transfers heat to the water of a first temperature to produce water of a second, higher temperature; and an outlet configured to receive the water of a second, higher temperature from the heating component.

According to an embodiment, the controller is in wired or wireless communication with a communications portal configured to: (i) receive a command to provide heated water; and (ii) transmit the command to provide heated water to the induction driver.

According to an embodiment, the water is inside a pipe, and wherein the induction coil surrounds the pipe.

According to an embodiment, the system further includes a temperature sensor in communication with the controller.

According to an embodiment, the controller is configured to control the induction driver based at least in part on temperature data from the temperature sensor.

According to an embodiment, the controller is configured to control the induction driver based at least in part on the formula:

P=T_{final}−T_{first}

wherein P is an operation parameter for the induction driver, T_{first} is the first, pre-heated temperature of the water, and is T_{final} is the second, post-heated temperature of the water.

According to an embodiment, the controller is configured to control the induction driver based at least in part on the formula:

P=T_{final}−T_{second}

wherein P is an operation parameter for the induction driver, T_{second} is a post-heated temperature of the water, and is T_{final} is a desired post-heating temperature of the water.

According to an embodiment, the system comprises a first temperature sensor located between the inlet and the metal heating component and being configured to obtain pre-heating temperature data; and further comprises a second temperature sensor located between the metal heating component and the outlet and being configured to obtain post-heating temperature data.

According to an embodiment, the system further comprises a user interface configured to provide one or more commands or settings to the controller.

According to an aspect is an on-demand water heating system. The system includes: an inlet configured to receive water of a first temperature from a water supply; a controller in wired or wireless communication with a communications portal configured to receive a command to provide heated water; a metal heating component configured to transfer heat to the water of a first temperature received via the inlet, the heating region comprising: (i) an induction driver configured to receive a command input from the controller; (iii) an induction coil configured to induce, in response to a current from the induction driver, eddy currents in the metal heating component, wherein induction of eddy currents heats the metal heating component, and wherein the heated metal heating component transfers heat to the water of a first temperature to produce water of a second, higher temperature; a first temperature sensor located between the inlet and the metal heating component and being configured to obtain pre-heating temperature data; an outlet configured to receive the water of a second, higher temperature from the heating component; and a second temperature sensor located between the metal heating component and the outlet and being configured to obtain post-heating temperature data; wherein the controller is configured to control the induction driver based at least in part on temperature data from the first and/or second temperature sensor.

According to an aspect is a method for providing heated water. The method includes the steps of: (i) providing a heating system comprising a metal heating component configured to transfer heat to water of a first temperature received via an inlet, the heating region comprising an induction driver and an induction coil; (ii) receiving, at a controller, a request for heated water; (iii) sending, by the controller, a command to the induction coil for heated water; (iv) initiating a current in the induction coil; and (v) inducing, in response to the current from the induction driver, eddy currents in the metal heating component, wherein induction of eddy currents heats the metal heating component, and wherein the heated metal heating component transfers heat to the water of a first temperature to produce water of a second, higher temperature.

According to an embodiment, the method further includes the step of obtaining, by a first temperature sensor located between the inlet and the metal heating component, pre-heating temperature data; and obtaining, by a second temperature sensor located between the metal heating component and the outlet, post-heating temperature data.

According to an embodiment, the method further includes the step of receiving, via a user interface, one or more commands or settings.

These and other aspects of the invention will be apparent from reference to the embodiments described hereinafter.

### BRIEF DESCRIPTION OF THE DRAWINGS

The present invention will be more fully understood and appreciated by reading the following Detailed Description in conjunction with the accompanying drawings, in which:

FIG. 1 is a schematic representation of an on-demand water heating system utilizing magnetic induction, in accordance with an embodiment.

FIG. 2 is a schematic representation of an on-demand water heating system utilizing magnetic induction, in accordance with an embodiment.

FIG. 3 is a schematic representation of an on-demand water heating system floorplan, in accordance with an embodiment.

### DETAILED DESCRIPTION

The present disclosure describes various embodiments of a method, system, and apparatus for heating water using in-line magnetic induction systems. The heating system utilizes eddy currents created via one or more magnetic fields acting upon a stationary ferrous core. The device can be housed within an enclosure, which can in turn be connected to any existing water line, and can be connected to basic house voltage. During operation, cold water enters the enclosure, passes through the system, and leaves the system at a desired temperature setpoint greater than the initial inlet water temperature.

According to an embodiment, the apparatus works by magnetic induction rather than a flame or an electrical heating element. As cold water enters the device, it passes over or near a ferrous heating element. On the outside of the water pipe containing this element is an induction coil connected to an electronic induction driver. When a request is received to increase the water temperature, the induction coil energizes and creates eddy currents in the ferrous element (i.e., a plurality of electric current loops induced within the conductor by the changing magnetic field in the conductor, due to Faraday's law of induction), thereby creating heat. The heat generated is then passed off to the surrounding water and increases the water temperature. Once the water reaches a requested temperature setpoint, the device can open an outlet valve, sending the heated water to the end user (e.g. faucet, showerhead, home heating devices). The process is continuously repeated for the duration of water demand, thus maintaining a steady flow of water at the desired temperature. Once the demand for water is no longer present, power is removed from the induction coil, stopping all heat input into the system. The system will then close the valve and stop water flow.

According to an embodiment, the user can adjust the temperature setpoint at any time before or during use, such as via a control module that can be hardwired to, or communicate electronically with, the apparatus. For example, the control module can be a user interface disposed on or within the apparatus, or can be a remote user interface. As one example, the remote user interface can be disposed at a location such as a bathroom or circuit breaker box, and can be wired or wirelessly connected to the apparatus and/or an apparatus control unit. As the user increases or decreases the requested temperature setpoint, the device rapidly adjusts the induction coil driver to bring the water temperature to the current desired value.

Notably, adjusting the temperature setpoint for the apparatus only affects the temperature of the water leaving the apparatus. This heated water can still be mixed with other water temperatures downstream of the on-demand water heating apparatus, similar to traditional water heating systems.

The device utilizes several inputs to complete the task. These inputs include temperature sensors and flow sensors. Inputs are programmed to adjust the strength and frequency of the magnetic field, thereby controlling the power output of the induction coil, which subsequently adjusts the outlet to the requested temperature. If water is desired with no additional heat added, the device opens the discharge valve without energizing the induction coil, allowing water to flow to the end user at the current inlet temperature.

This device provides numerous advantages. For example, the system drastically reduces water waste, as there is no need to “run” water until a desired temperature is reached. There is reduced energy consumption because, for example, there is no need to keep stored water continuously heated, and the improved system captures heat generated. Further, there is reduced construction material use because, for example, there is no water storage tank, and no need for separate cold and hot water piping.

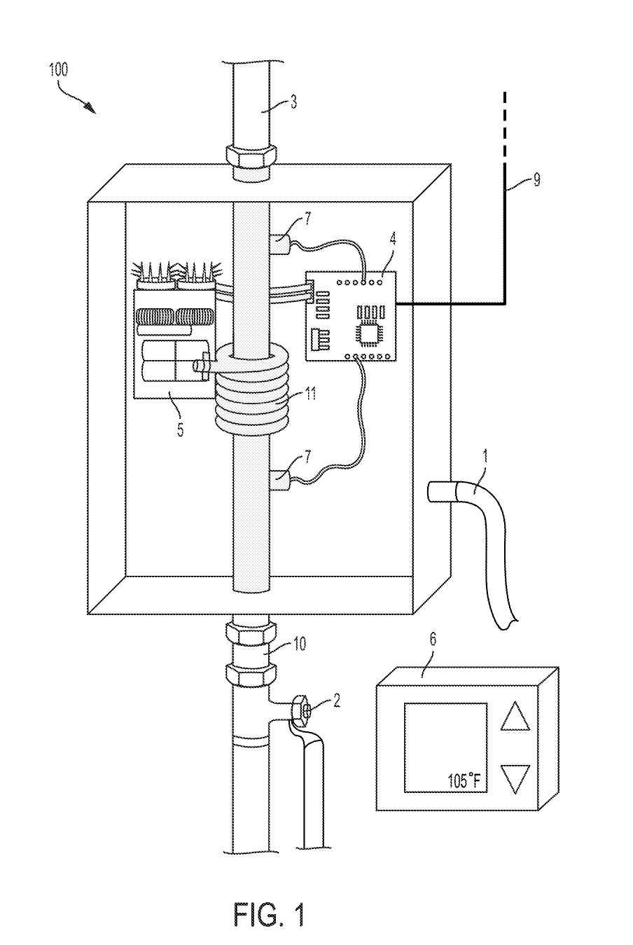

Referring to FIG. 1, in one embodiment, is on-demand water heating system 100 utilizing magnetic induction. The on-demand water heating system 100 may be any of the systems described or otherwise envisioned herein. According to this embodiment, on-demand water heating system 100 comprises a power supply 1. For example, the system may be permanently or semi-permanently hard-wired into the structure's electrical system, such as the electrical supply of a house or other building. The system may also be temporarily connected to a structure's electrical system, and thus may have some mobility.

According to an embodiment, on-demand water heating system 100 also comprises an inlet 10, with an optional isolation valve or hook-up 2. The water supply will be provided to the on-demand water heating system 100 via inlet 10. The isolation valve 2 could be utilized, for example, to turn off the water supply during installation or maintenance of the system. For example, as shown in FIG. 1, the valve 2 controls the supply of water to the section of the water pipe comprising on-demand water heating system 100. Although shown in close proximity to the system, the isolation valve 2 may also be remote from the system.

The on-demand water heating system 100 can also comprise a discharge or outlet 3. The water—which has been heated by the on-demand water heating system 100—will leave the system via the discharge or outlet 3. According to an embodiment, the discharge or outlet 3 will lead to or be directly associated with an appliance or feature requiring heated water. For example, the discharge or outlet 3 may lead to a sink, shower, bathtub, heating system, dishwasher, washing machine, or wide variety of other appliances or features. According to an embodiment, the discharge 3 can comprise a valve that controls the flow of water from the system. For example, once the water reaches a requested temperature setpoint, the outlet valve can open, thereby sending the heated water to the end user (e.g. faucet, showerhead, home heating devices).

According to an embodiment, on-demand water heating system 100 also comprises a control circuit 4, which may be a controller or processor. The controller, processor, or control circuit controls the functioning of the induction driver 5, and thus controls the heating of the water via system 100. The control circuit is in communication via a communications portal 9—which may be wired or wireless—to one or more appliances or features requiring heated water, and is configured to provide the on-demand water heating system 100 with information about the heated water demands of the appliance or feature. For example, the control circuit may be in directed wired communication with a sink, and receives a command from the sink via communications portal 9 to supply hot water to the sink. The control circuit receives and interprets the command, and sends a command to the induction driver 5 to heat water flowing through the water supply pipe. Later, the control circuit receives a command from the sink via communications portal 9 to stop the supply of hot water to the sink. The control circuit receives and interprets the command, and sends a command to the induction driver 5 to stop heating the water. According to another embodiment, the control circuit is in wireless communication with an appliance or feature requiring heated water, in which case the control circuit 4 comprises a wireless communications module to facilitate the wireless communication. The wireless communication may utilize any form of wireless technology, including but not limited to one or more of WiFi, Bluetooth, ZigBee, NFC, and others. Thus, the appliance or feature requiring heated water can comprise or be in direct communication with a wireless communications module to facilitate the wireless communication with on-demand water heating system 100.

The control circuit 4 may also comprise, and/or be in communication with, one or more temperature sensors 7. Temperature sensor 7 obtains sensor data regarding the temperature of the water within a section of the pipe, and sends that information via a wired and/or wireless connection to the control circuit 4. Referring to FIG. 1, for example, the on-demand water heating system 100 comprises a specialized section of pipe positioned between inlet 10 and outlet 3, which comprises a pre-induction temperature sensor 7 and a post-induction temperature sensor 7. Among other functions, the temperature sensors can operate cooperatively to control the induction by the induction driver 5. For example, the operation of the induction driver 5 can be dependent at least in part on the temperature of the water being supplied to the on-demand water heating system 100. This information is obtained by the pre-induction temperature sensor 7 and sent to the control circuit 4. For example, if the water being supplied to the system has a first temperature, and the control circuit is commanded to heat the system to a final temperature, the operation of the induction driver 5 may depend in part on the total difference between the first temperature and the final temperature (i.e., operation parameter P=final temperature T_{f}−first temperature T_{f}). The operation of the induction driver 5 can also be dependent at least in part on the temperature of the water after it is heated. This information is obtained by the post-induction temperature sensor 7 and sent to the control circuit 4. For example, if the heated water leaving the system has a second temperature, and the control circuit is commanded to heat the system to a final temperature, the operation of the induction driver 5 may depend in part on the total difference between the second temperature and the final temperature (i.e., operation parameter P=final temperature T_{f}−second temperature Tₛ). The temperature sensor may also be a non-intrusive sensor configured to attached or clip-on to the pipe. The temperature sensor may be located in proximity to the on-demand water heating system 100, or it may be located in proximity to the appliance or feature requiring heated water.

According to an embodiment, on-demand water heating system 100 also comprises an induction driver 5. The induction driver is in wired or wireless communication with the control circuit 4, and receives commands from the control circuit regarding when to begin operation and when to cease operation, and may also receive commands from the control circuit regarding one or more parameters of operation. According to an embodiment, the induction driver operates via magnetic induction. As the cold water enters system 100, it passes over or near a ferrous heating element. On the outside of the water pipe containing this element is an induction coil 11 connected to an electronic induction driver. When a command is received from the control circuit to increase the water temperature, the induction coil energizes and creates eddy currents in the ferrous element (i.e., a plurality of electric current loops induced within the conductor by the changing magnetic field in the conductor, due to Faraday's law of induction), thereby creating heat. The heat generated is then passed off to the surrounding water and increases the water temperature. The process is continuously repeated for the duration of water demand, thus maintaining a steady flow of water at the desired temperature. Once the demand for water is no longer present, power is removed from the induction coil, stopping all heat input into the system.

According to an embodiment, on-demand water heating system 100 also comprises a user control panel 6. The user control panel can comprise one or more inputs, outputs, or displays for receiving information from and providing information to a user. For example, the user control panel may comprise a temperature output or display showing one or more of the pre-induction water temperature as measured by pre-induction temperature sensor 7, and the post-induction water temperature as measured by post-induction temperature sensor 7. The user control panel may also comprise a user interface—such as a GUI comprising buttons, slides, touchscreen, or other interface—to obtain information from the user about one or more parameters of the system. For example, the user can provide a temperature setting for the device, such as the final temperature setting for the heated water, among many other settings.

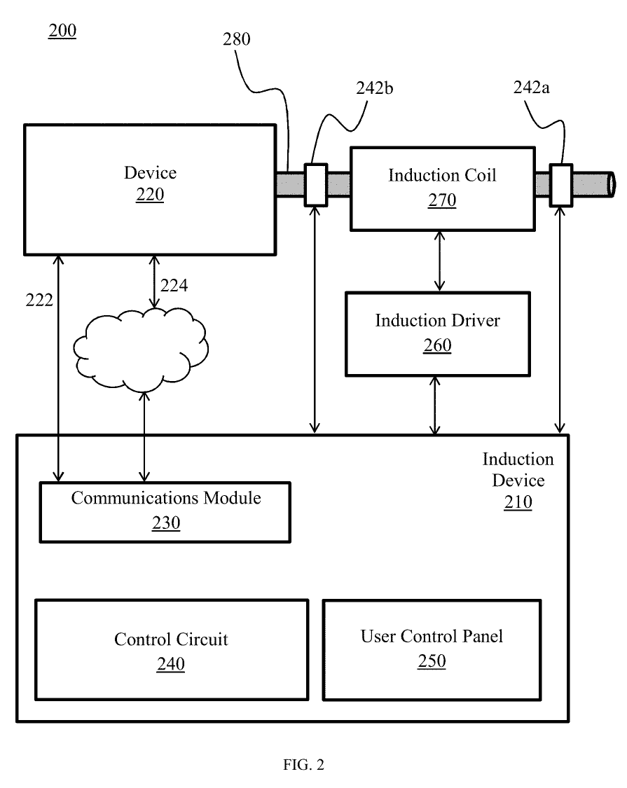

Referring to FIG. 2, in one embodiment, is a schematic representation of an on-demand water heating system 200. The on-demand water heating system 200 may be any of the systems described or otherwise envisioned herein. According to this embodiment, on-demand water heating system 200 is in wired 222 or wireless 224 communication with an induction device 210, optionally via a communications module 230.

The induction device 210 comprises or be in communication with a control circuit 240 and a user control panel 250. The induction device 210 can also comprise or be in communication with a pre-induction temperature sensor 242a and/or a post-induction temperature sensor 242b. The induction device 210 comprises and/or is in communication with an induction driver 260, which controls an induction coil 270 to heat water within pipe 280.

According to an embodiment, device 220—which is a hot-water consuming device such as an appliance, fixture, or other device—sends a demand for warmed water via wired 222 or wireless 224 communication to the communications module 230 of the induction device 210. The control circuit 240 receives the command, compares the command to both information previously or contemporaneously received from the user control panel and/or the pre-induction temperature sensor 242a, and sends an appropriate command to the induction driver 260. The induction driver 260 controls the induction coil 270 to heat the water in the pipe 280. The post-induction temperature sensor 242b measures the temperature of the heated water and communicates that to the control circuit 240, which can adjust or maintain the heating parameters. When device 220 sends a stop command via wired 222 or wireless 224 communication to the communications module 230 of the induction device 210, the control circuit 240 receives the command and sends an appropriate command to the induction driver 260. The induction driver 260 controls the induction coil 270 to stop heating the water in the pipe 280.

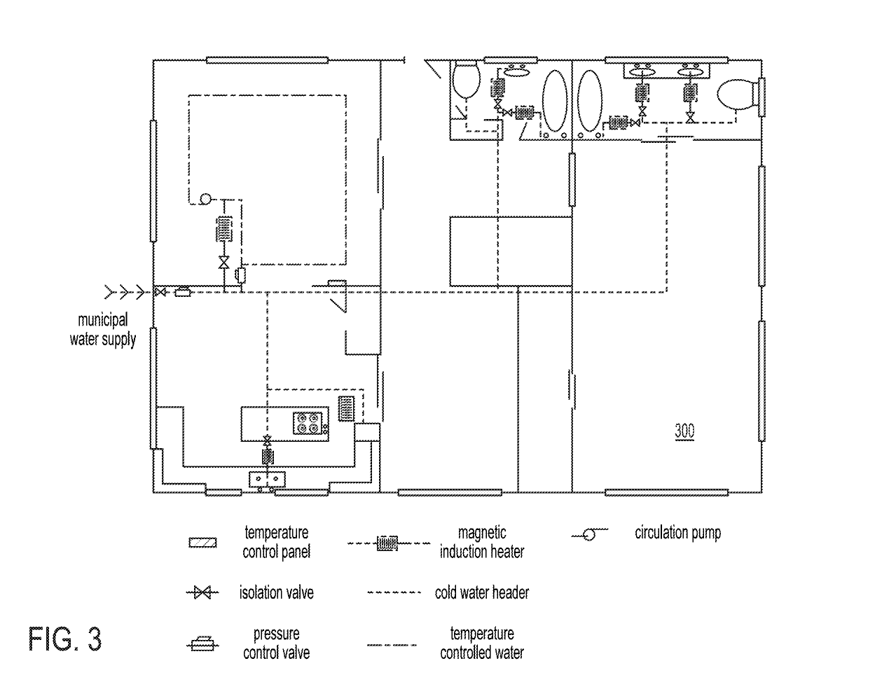

Referring to FIG. 3, in one embodiment, is a schematic representation of a floorplan 200 of a house or building. The house or building depicted in floorplan 300, in one embodiment, has a kitchen sink requiring heated water, three bathroom vanity sinks requiring heated water, two bathtubs requiring heated water, and a heating system requiring heated water. According to an embodiment, the floorplan comprises a plurality of magnetic induction heaters, with a magnetic induction heater supplying water to one or more devices (sinks, bathtub, heating system, etc.). One or more of the magnetic induction heater systems can comprise or function cooperatively with additional components, including a pressure control valve and a circulation pump. According to the embodiment depicted in FIG. 3, the system also comprises one or more temperature control panels for receiving information from and providing information to a user.

Although the present invention has been described in connection with a preferred embodiment, it should be understood that modifications, alterations, and additions can be made to the invention without departing from the scope of the invention as defined by the claims.

What is claimed is:

1. An on-demand water heating system, comprising:
an inlet configured to receive water of a first temperature from a water supply;
a metal heating component configured to transfer heat to the water of a first temperature received via the inlet, the heating region comprising: (i) a controller; (ii) an induction driver configured to receive a command input from the controller; (iii) an induction coil configured to induce, in response to a current from the induction driver, eddy currents in the metal heating component, wherein induction of eddy currents heats the metal heating component, and wherein the heated metal heating component transfers heat to the water of a first temperature to produce water of a second, higher temperature; and
an outlet configured to receive the water of a second, higher temperature from the heating component.

2. The system of claim 1, wherein the controller is in wired or wireless communication with a communications portal configured to: (i) receive a command to provide heated water; and (ii) transmit the command to provide heated water to the induction driver.

3. The system of claim 1, wherein the water is inside a pipe, and wherein the induction coil surrounds the pipe.

4. The system of claim 1, further comprising a temperature sensor in communication with the controller.

5. The system of claim 4, wherein the controller is configured to control the induction driver based at least in part on temperature data from the temperature sensor.

6. The system of claim 5, wherein the controller is configured to control the induction driver based at least in part on the formula:
P=T_{final}−T_{first}
wherein P is an operation parameter for the induction driver, T_{first} is the first, pre-heated temperature of the water, and is T_{final} is the second, post-heated temperature of the water.

7. The system of claim 5, wherein the controller is configured to control the induction driver based at least in part on the formula:
P=T_{final}−T_{second}
wherein P is an operation parameter for the induction driver, T_{second} is a post-heated temperature of the water, and is T_{final} is a desired post-heating temperature of the water.

8. The system of claim 1, wherein the system comprises a first temperature sensor located between the inlet and the metal heating component and being configured to obtain pre-heating temperature data; and further comprises a second temperature sensor located between the metal heating component and the outlet and being configured to obtain post-heating temperature data.

9. The system of claim 1, wherein the system further comprises a user interface configured to provide one or more commands or settings to the controller.

10. An on-demand water heating system, comprising:
an inlet configured to receive water of a first temperature from a water supply;
a controller in wired or wireless communication with a communications portal configured to receive a command to provide heated water;
a metal heating component configured to transfer heat to the water of a first temperature received via the inlet, the heating region comprising: (i) an induction driver configured to receive a command input from the controller; (iii) an induction coil configured to induce, in response to a current from the induction driver, eddy currents in the metal heating component, wherein induction of eddy currents heats the metal heating component, and wherein the heated metal heating component transfers heat to the water of a first temperature to produce water of a second, higher temperature;
a first temperature sensor located between the inlet and the metal heating component and being configured to obtain pre-heating temperature data;
an outlet configured to receive the water of a second, higher temperature from the heating component; and
a second temperature sensor located between the metal heating component and the outlet and being configured to obtain post-heating temperature data;
wherein the controller is configured to control the induction driver based at least in part on temperature data from the first and/or second temperature sensor.

11. The system of claim 10, further comprising a user interface configured to provide one or more commands or settings to the controller.

12. A method for providing heated water, the method comprising the steps of:
providing a heating system comprising a metal heating component configured to transfer heat to water of a first temperature received via an inlet, the heating region comprising an induction driver and an induction coil;
receiving, at a controller, a request for heated water;
sending, by the controller, a command to the induction coil for heated water;
initiating a current in the induction coil; and
inducing, in response to the current from the induction driver, eddy currents in the metal heating component, wherein induction of eddy currents heats the metal heating component, and wherein the heated metal heating component transfers heat to the water of a first temperature to produce water of a second, higher temperature.

13. The method of claim 12, wherein the controller is in wired or wireless communication with a communications portal configured to: (i) receive a command to provide heated water; and (ii) transmit the command to provide heated water to the controller.

14. The method of claim 12, wherein the water is inside a pipe, and wherein the induction coil surrounds the pipe.

15. The method of claim 12, wherein the heating system further comprises a temperature sensor in communication with the controller.

16. The method of claim 14, wherein the command send by the controller to the induction coil for heated water is based at least in part on temperature data from the temperature sensor.

17. The method of claim 12, further comprising the steps of:
obtaining, by a first temperature sensor located between the inlet and the metal heating component, pre-heating temperature data; and
obtaining, by a second temperature sensor located between the metal heating component and the outlet, post-heating temperature data.

18. The method of claim 17, wherein the command send by the controller to the induction coil for heated water is based at least in part on temperature data from the first and second temperature sensors.

19. The method of claim 12, further comprising the step of receiving, via a user interface, one or more commands or settings.

20. The method of claim 12, wherein the controller is configured to control the induction driver based at least in part on the formula:
P=T_{final}−T_{first}
wherein P is an operation parameter for the induction driver, T_{first} is the first, pre-heated temperature of the water, and is T_{final} is the second, post-heated temperature of the water.
